(19) United States
(12) Patent Application Publication
(10) Pub. No.: US 2024/0142925 A1
(43) Pub. Date: May 2, 2024

(54) CONTROL SYSTEM

(71) Applicant: Transportation IP Holdings, LLC, Norwalk, CT (US)

(72) Inventors: Jeffery Armstrong, Haslet, TX (US); Tab Robert Mong, Erie, PA (US)

(21) Appl. No.: 18/450,850

(22) Filed: Aug. 16, 2023

Related U.S. Application Data
(60) Provisional application No. 63/420,548, filed on Oct. 29, 2022.
(60) Provisional application No. 63/420,549, filed on Oct. 29, 2022.

(51) Int. Cl. G05B 15/02

(52) U.S. Cl. CPC G05B 15/02

(57) ABSTRACT

A powered system is provided that can include a control system having processors communicatively coupled with each other by a data plane of a communication network. The processors may run software applications in containers to control operation of the powered system. The processors may switch which of the processors are running different ones of the software applications operating in different ones of the containers. The processors may change a mode of at least one of the containers to a shadow mode that prevents output from at least a first application of the software applications that is running in the at least one of the containers operating in the shadow mode from changing operation of the powered system.

### CROSS-REFERENCE TO RELATED APPLICATIONS

This application claims priority to U.S. Provisional Application No. 63/420,548 (filed 29 Oct. 2022) and to U.S. Provisional Application No. 63/420,549 (filed 29 Oct. 2022), the entire disclosures of which are incorporated herein by reference.

### BACKGROUND

### Technical Field

The subject matter described herein relates to systems and methods that control operation of powered systems, such as vehicles or vehicle systems (formed from a single or multiple vehicles), or stationary systems.

### Discussion of Art

Powered systems such as vehicles may operate under the control of many different devices operating under the control of different software applications. Often, the architecture of these applications uses point-to-point data connections between the applications for control and communication with external information (e.g., input/output devices, communication devices, etc.). This architecture can be rigid and not easily scalable or inexpensive to test. For example, operation of the applications may be limited to the embedded deployment node of the applications. New or changed software applications used in connection with control of a vehicle may require recompiling other applications, changing the code (e.g., source code) of other applications to work with the new or updated software applications, etc.

As another example, this type of architecture can prevent a new or updated software application from operating on a powered system in real time (e.g., as the powered system is operating) until operation of the new or updated software application has been tested, usually in a simulation or simulated operating environment.

It may be desirable to have a system and method that differs from those that are currently available.

### BRIEF DESCRIPTION

In one example, a powered system is provided that can include a control system having processors communicatively coupled with each other by a data plane of a communication network. The processors may run software applications in containers to control operation of the powered system. The processors may switch which of the processors are running different ones of the software applications operating in different ones of the containers. The processors may change a mode of at least one of the containers to a shadow mode that prevents output from at least a first application of the software applications that is running in the at least one of the containers operating in the shadow mode from changing operation of the powered system.

In another example, a method is provided that can include communicatively coupling processors of a control system with each other by a data plane of a communication network, running software applications in containers using the processors to control operation of the powered system, switching which of the processors are running different ones of the software applications operating in different ones of the containers, and changing a mode of at least one of the containers to a shadow mode that prevents output from at least a first application of the software applications that is running in the at least one of the containers operating in the shadow mode from changing operation of the powered system.

In another example, another powered system is provided that may include a control system having processors communicatively coupled with each other by a data plane of a communication network. The processors may run software applications in containers to control operation of the powered system. The processors may switch the containers between operating in a normal mode and a shadow mode. The software applications running in the containers in the normal mode may generate output that controls operation of the powered system. The software applications running in the containers in the shadow mode may generate output that does not control operation of the powered system.

### BRIEF DESCRIPTION OF THE DRAWINGS

The subject matter may be understood from reading the following description of non-limiting embodiments, with reference to the attached drawings, wherein below:

FIG. 1 illustrates one example of a control system;

FIG. 2 schematically illustrates operation of the control system shown in FIG. 1;

FIG. 3 illustrates operation of the same control system shown in FIG. 2 but during a different, second instance in time or during a different, second time period than FIG. 2; and

FIG. 4 illustrates one example of operation of the control system with a first container operating in shadow mode and a second container operating in a normal mode.

### DETAILED DESCRIPTION

Embodiments of the subject matter described herein relate to control systems and methods that allow for software applications that control operation or relate to control of operation of powered systems to be easily added, removed, replaced, and/or modified without having to change other software applications of the powered systems, such as compiling or re-compiling the other applications, changing the source code of the other applications, etc. The control systems and methods described herein provide for software containers to be deployed in a variety of locations or instances along or on seamless control/data planes (SCDP) of the control systems without requiring re-compiling and/or changing the code of other applications. The control systems may provide modular base systems with many processing nodes that allow distribution of software applications across all or many nodes (e.g., processors, such as microprocessors, field programmable gate arrays, integrated circuits, etc.) of the control system. This allows for the full or more potential of the processing power of the control system to be utilized across the SCDP.

Integration of the SCDP with software containers can provide a more flexible, modular application architecture for control of the powered system than some or all currently known software architectures. This can be accomplished by layering the data plane into the software containers at build time. When the container(s) is or are launched, the data plane may be part of the application(s) operating in the container(s). The containerization of the applications along with the data plane (e.g., operating the applications within containers along the data plane) can allow for the application. The SCDP can allow applications to utilize the potential of processor power attached to the data plane.

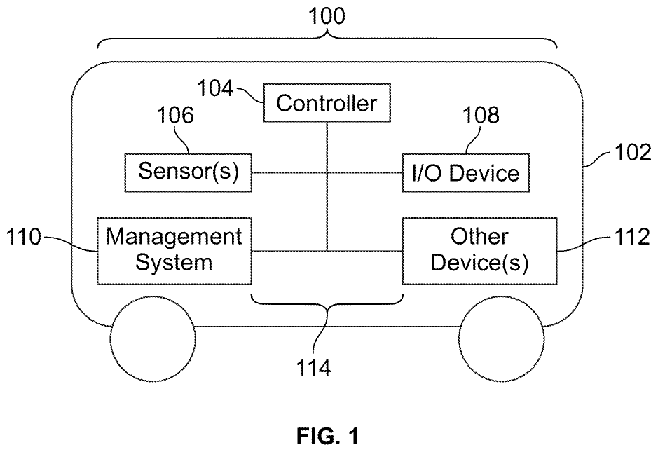

FIG. 1 illustrates one example of a control system 100. The control system includes various devices that operate to control operation of a powered system 102. The powered system can be a mobile system, such as a vehicle (e.g., a rail vehicle, automobile, truck, bus, manned or unmanned aircraft, mining vehicle, marine vessel agricultural vehicle, etc.), or a stationary system. The devices of the control system can include a controller 104 that represents hardware circuitry connected with and/or including one or more processors that perform the operations described herein in connection with the control system. The applications described herein may direct operation of the control system and other device. Another device of the control system may be one or more sensors 106 that sense characteristics of the powered system, other devices, the environment around the powered system, etc. The control system may include an input/output device 108 (“I/O Device” in FIG. 1), such as a touchscreen, keyboard, electronic mouse, electronic display other than a touchscreen, switch, lever, button, speaker, microphone, etc., used to present information to and/or receive information from operators of the powered system. The control system may include a management system 110 that represents hardware circuitry including and/or connected with one or more processors that calculate and/or dictate operational settings of the powered system. The management system may calculate settings to achieve one or more goals of the powered system subject to various constraints. As one example, the management system may calculate throttle settings, speeds, brake settings, and the like, for different locations, times, distances, etc. that a vehicle is to use to reduce fuel consumption, reduce battery energy usage, reduce emission generation, reduce audible noise, etc. (relative to operating the vehicle according to other settings). One or more other devices 112 can represent other computerized devices, systems, assemblies, or the like, that may receive input, make one or more calculations, determinations, or the like, based on the input to generate output, and/or provide output to another device (e.g., a propulsion system of a vehicle, a braking system of a vehicle, an alternator or generator of a mobile or stationary system, additional processors, etc.). In one example, at least one of the devices may be an artificial intelligence or machine learning system or machine.

The devices of the powered system may be communicatively coupled with each other by a communication network 114. This communication network can be formed from communication pathways provided by or extending in conductive pathways (e.g., cables, buses, etc., such as Ethernet cables or connections) and/or wireless pathways. Some devices may be publisher devices or publishers that generate output. Some devices may be listener devices or listeners that obtain or receive the output from the publishers to perform some operation (e.g., control of the powered system, calculation of output, etc.). Some devices may be both publishers and listeners that receive data from another device, make a calculation, determination, etc. based on the received data, and generate data as an output for another device and/or perform some action (e.g., change operation of the powered system, such as changing a speed, throttle setting, etc., of a vehicle).

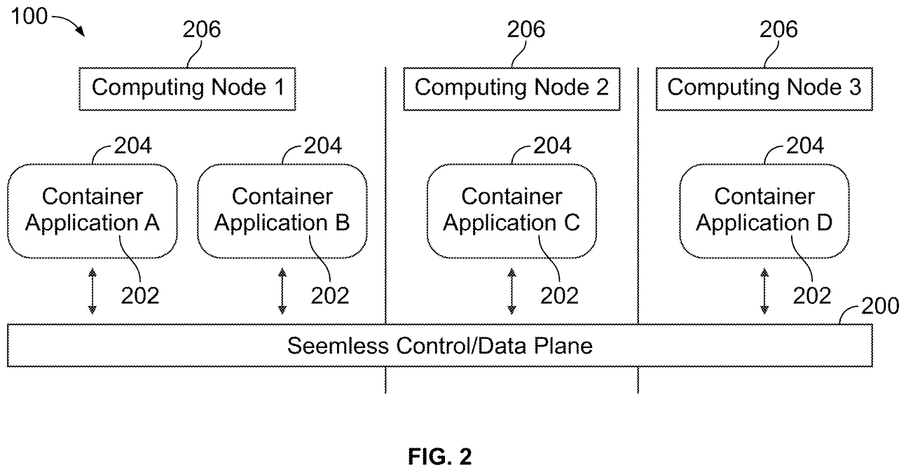

FIG. 2 schematically illustrates operation of the control system shown in FIG. 1. The control system includes a control plane and/or data plane 200 through which data is communicated between or among software applications 202 operating within different software containers 204 and operating on different ones of the devices of the powered system. The software applications may operate within the software containers in the control system that may be a container-based platform that provides a container-centric infrastructure for operation of the devices. Examples of container-based or container-centric infrastructures may include Kubernetes, OpenStack, Mesos/Marathon, Docker swarm, OpenShift, VMware, Amazon ECS, etc. One or more of these infrastructures may be used in the control system.

Processor(s) of the control system shown in FIG. 1 may represent or create nodes 206 of the container-based infrastructure of the control system. At least one of these nodes may control initiation or deployment, operation, and/or termination of one or more containers in which different ones of the software applications may operate. The nodes also can be referred to as virtual machines operating on the processor(s). The containers may be Kubernetes containers or another type of container in which different software applications may operate.

The applications operating within the containers in the different nodes can communicate with each other in a data distribution service (DDS) network configuration of the control system. As described above, different applications can operate in one or more of the devices as publishers that output information and/or listeners that obtain or receive information to perform work (e.g., control of the powered system) and/or generate information for other listeners and/or publishers.

The control or data plane can represent communication pathway(s) within the communication network, such as Ethernet connections, wireless connections, or the like, between the devices. In one embodiment, in contrast to a point-to-point communication scheme or configuration, the control system may operate as in a DDS scheme or configuration where, instead of data being sent from one application and addressed to another application or applications, the data is communicated along or through the control plane or data plane and obtained by the applications operating within the different containers as needed or according to a communication schedule.

The software containers can be initiated by the processors to be deployed anywhere on the control/data plane with no recompiling and with no change to the software code of the application. For example, FIG. 2 illustrates operation of the control system during a first instance in time or during a first time period where a first processor (“Computing Node 1” in FIG. 2) operates two separate containers, with a different software application operating in each of the different containers (“Application A” and “Application B” in FIG. 2). Another processor (“Computing Node 2” in FIG. 2) may run another container in which another application operates (“Application C” in FIG. 2). Another processor (“Computing Node 3” in FIG. 2) may run another container in which another application operates (“Application D” in FIG. 2). One or more of these applications may output data into the data plane at scheduled intervals, on-demand, or the like. The same or other applications may obtain or retrieve data communicated along the data plane to perform work or generate other output that is then sent along the data plane. For example, sensors may output sensor data onto the data plane as the data is generated, at scheduled times, or the like. Other devices, such as the I/O device, can obtain this sensor data via the data plane and generate output, such as notifications to operators of the powered systems. The management system may obtain sensor data and/or other data (e.g., input provided via the I/O device, data from sensors, data from other devices, etc.) and may perform work (e.g., control movement or other operation of the powered system) and/or generate other data as output for communication along the data plane (e.g., throttle settings, brake settings, and/or other operational settings of the powered system).

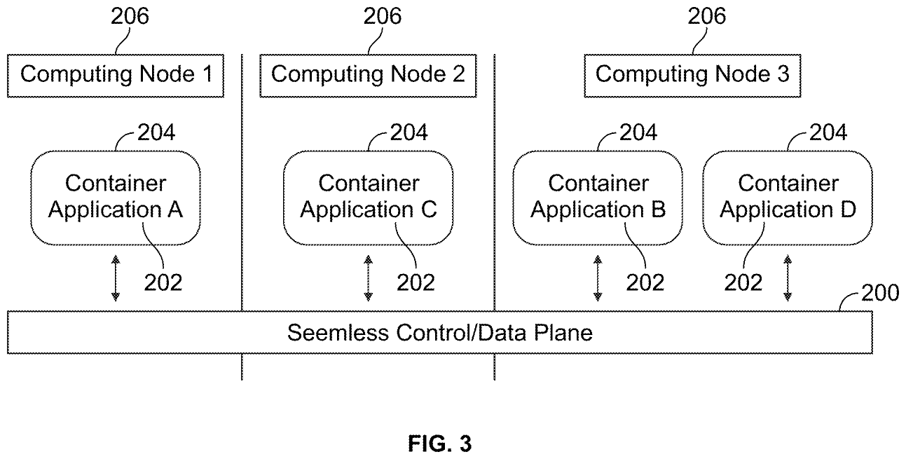

But due to a need for different or increased processing power, the control system may change which containers are operating on different processors or nodes. FIG. 3 illustrates operation of the same control system shown in FIG. 2 but during a different, second instance in time or during a different, second time period than FIG. 2. In FIG. 3, the first processor now operates only one container with the Application A operating in the container. The second processor may still run the same component in which the same application operates (“Application C”). The third processor may continue to run the fourth application (“Application D”), but also may initiate or create a software container in which the second application (“Application B”) now operates. Stated differently, the container previously running Application B on the first processor now runs on the third processor. This container and software application can move from the first processor to the third processor using the container configurations or scheme to shift processing loads but without having to re-compile the code of Application B, without having to change the code of Application B (or any other application), etc. The applications can continue publishing and listening for data along the control/data plane as described above. Other containers can be created with other applications running within the containers, containers can be eliminated (so that the applications running in those containers no longer operate), and/or containers may move between nodes or processors to ensure that there is sufficient processing power for running the different applications.

Each application can receive input from and/or generate output to the control/data plane regardless of which container the application is running within and/or regardless of which processor is running the application within the container. The applications may not be required to change in any way regardless of which processor or container that the applications are running on or within.

In one example, when a container is created (e.g., launched), the data plane may become part of the application running within the container. This can allow the container to be deployed anywhere along the control/data plane, and the control/data plane allows for applications to utilize the full potential of all processor power attached to the control/data plane. The data plane can use Ethernet technologies or other communication technologies to connect the processors/nodes.

At a time that the control system is initialized or at a time that a container is launched, the application and container may be discovered by other applications connected to the control/data plane, and the launched container/application may discover other containers/applications on the control/data plane. Because data moves or is communicated on the control/data plane in a logical manner, the physical constraints of where (e.g., which processors) applications and containers may operate on can be removed. For example, the publisher devices can simply publish data to the control/data plane, without concern or limits on where the subscriber devices are located so long as the devices are connected with the control/data plane.

The control system can allow for accelerated testing of new or modified applications since the new or modified applications only need to test to ensure that the applications can connected to the control/data plane. The control system can become a software application that is agnostic to the hardware platform of the control system and allow for automated virtual testing of new or modified applications. This can decrease engineering cycle time by decreasing implementation testing and increasing initial quality, thereby leading to decreased validation time for the new or modified applications. The applications can be modified to make corrections (e.g., fix software bugs or unintended features), to add features or operations to the applications, or the like. The control/data plane may allow for hardware abstraction of the control system or applications running on the control data plane. This can reduce the impact of hardware obsolescence.

The modularity of the application containers of the control system optionally can provide for one or more of the applications operating in a container to operate in a shadow mode. This mode can allow for in-field testing of an application using real data in a real-time manner without disrupting operation of the control system. Currently, there may be no way to validate new functionality in a software application in the field using real time field data in current time. For example, some currently known control systems may not be able to run a new or modified software application while the control system is operating (e.g., to produce work, to move persons and/or cargo between locations, etc.) as the full impact of the new or modified software application on the other devices may not be known. Instead, these new or modified software applications may need to be tested away from a control system operating in the field or real world. For example, the new or modified software application may need to operate in a simulation to determine how the application may operate or impact the operation of other applications. But not all impacts of the new or modified application may be known in such a simulation, as the simulation may only be monitored for some, but not all, possible impacts of the software application.

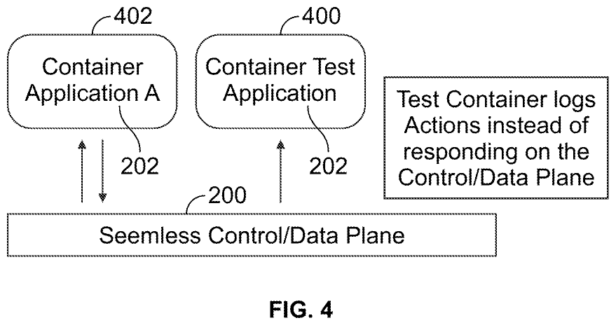

Allowing for real-time, real data analysis of improvements and defect fixes in the field during operation of the powered system without affecting the existing control system that is executing using a test container deployed within the control system. FIG. 4 illustrates one example of operation of the control system with a first container 400 operating in shadow mode and a second container 402 operating in a normal mode. The shadow mode container can be created to listen for (e.g., receive) data on the control/data plane, but does not perform work or take action that changes operation of another device, or the powered system based on the data. This can be used to verify a performance improvement or a defect resolution ensuring confidence that the verification can be done without impacting the powered system in service, while still utilizing the data and environment advantages of real time production data.

The application operating within the shadow mode container may receive data from the data plane and perform one or more operations, analysis, etc. using that data. But instead of publishing output data or otherwise sending data that is output based on the operations, analysis, etc. performed on the received data, the shadow mode application can log or record the output (or can send the output to another container in which an application that logs or records the output of the shadow mode application operates). This can allow the shadow mode application to operate and to record the results of operation of the shadow mode application, but without the operation of the shadow mode application impacting operation of the powered system.

For example, the shadow mode application may be energy management system software that determines whether heaters or fans should be used to heat up or cool down batteries that power motor(s) of a vehicle to keep the temperatures of the batteries within acceptable limits. The software may receive data from the data plane from other applications (which may be operating within other containers that are in the normal operating mode and not the shadow mode). This data can include temperature measurements, current load or demand for energy from the batteries, calculated expectations of upcoming or future loads or demands for this energy, upcoming or expected temperatures, etc. The application operating within the shadow mode container can use this data to analyze and determine whether to activate a heater or cooler to change the temperature of the batteries. The application can generate output indicative of control signals that would cause the heater or cooler (e.g., other devices of the powered system) to heat or cool the batteries.

But because the application is operating in a shadow mode container, this output is generated by the application but not output to the control or data plane for communication to the heater or cooler devices. Instead, this output may be logged or otherwise recorded for analysis of operation of the application operating in the shadow mode.

In another example, the shadow mode application may be energy management system software that calculates throttle settings and/or brake settings of a vehicle to reduce fuel consumption, energy consumption, and/or emission generation. The software may receive data from the data plane from other applications (which may be operating within other containers that are in the normal operating mode and not the shadow mode). This data can include grades of routes, elevations, speed limits, weight of the vehicle, power output capabilities of the propulsion system of the vehicle, etc. The application operating within the shadow mode container can use this data to calculate the throttle settings and/or brake settings that reduce energy consumption, fuel consumption or emission generation (relative to other settings). The application can generate output indicative of control signals that would cause the throttle setting or brake setting of the vehicle to change.

If the application operating in the shadow mode container is approved for working to control operation of the powered system, the same application can be opened in another container that is not a shadow mode container. Optionally, the same application can remain operating in the same container, but the mode of the container may be switched from the shadow mode to a normal mode of operation. The application operating in the non-shadow mode container can then operate to control operation of the powered system. For example, the application that determines whether to control the heater or cooler can receive the same data and generate the same output, but with the output actually activating the heater or cooler to change the temperature of the batteries. In another example, the application that determines the throttle settings and/or brake settings can receive the same data and generate the same output, but with the output actually changing the throttle setting or brake setting of the vehicle. This can allow for real time and real world exposure of the new or modified application to production data, but without risking unsafe operation of the powered system if the new or modified application operates in unexpected ways.

In one example, a powered system is provided that can include a control system having processors communicatively coupled with each other by a data plane of a communication network. The processors may run software applications in containers to control operation of the powered system. The processors may switch which of the processors are running different ones of the software applications operating in different ones of the containers. The processors may change a mode of at least one of the containers to a shadow mode that prevents output from at least a first application of the software applications that is running in the at least one of the containers operating in the shadow mode from changing operation of the powered system.

The control system may provide real time data related to operation of the powered system to the software applications running in the containers in both a non-shadow mode and in the shadow mode along the data plane. The software applications running in the containers may provide the output based on data received from the data plane. The software applications running in the containers other than the container(s) in the shadow mode may provide the output that changes operation of the powered system. The software application or the software applications running in the container(s) in the shadow mode may provide the output that does not change the operation of the powered system.

The processors may log or record the output from the software application or the software applications running in the container(s) in the shadow mode. The processors may change the mode of another container of the containers from a non-shadow mode to the shadow mode. The processors may change the mode of these container(s) from the shadow mode to a non-shadow mode. The output from the software application or the software applications running in the container(s) that was switched from the shadow mode to the non-shadow mode may change the operation of the powered system.

In another example, a method is provided that can include communicatively coupling processors of a control system with each other by a data plane of a communication network, running software applications in containers using the processors to control operation of the powered system, switching which of the processors are running different ones of the software applications operating in different ones of the containers, and changing a mode of at least one of the containers to a shadow mode that prevents output from at least a first application of the software applications that is running in the at least one of the containers operating in the shadow mode from changing operation of the powered system.

The method also may include providing real time data related to operation of the powered system to the software applications running in the containers in both a non-shadow mode and in the shadow mode along the data plane. The method also may include providing the output from the software applications running in the containers based on data received from the data plane. The software applications running in the containers other than the container(s) in the shadow mode may provide the output that changes operation of the powered system. The software application or the software applications running in the container(s) in the shadow mode may provide the output that does not change the operation of the powered system.

The method also may include logging or recording the output from the software application or the software applications running in the container(s) in the shadow mode. The method also may include changing the mode of another container of the containers from a non-shadow mode to the shadow mode. The method may include changing the mode of the container(s) from the shadow mode to a non-shadow mode. The method may include changing the operation of the powered system with the output from the software application or the software applications running in the container(s) that was switched from the shadow mode to the non-shadow mode.

In another example, another powered system is provided that may include a control system having processors communicatively coupled with each other by a data plane of a communication network. The processors may run software applications in containers to control operation of the powered system. The processors may switch the containers between operating in a normal mode and a shadow mode. The software applications running in the containers in the normal mode may generate output that controls operation of the powered system. The software applications running in the containers in the shadow mode may generate output that does not control operation of the powered system.

The processors may provide real time data related to operation of the powered system to the software applications running in the containers in both the normal mode and in the shadow mode along the data plane. The processors may log or record the output from the software application or the software applications running in the shadow mode. The processors may change at least one of the containers from the normal mode to the shadow mode. The processors may change at least one of the containers from the shadow mode to the normal mode. The output from the software application or the software applications running in the container(s) that was switched from the shadow mode to the normal mode may change the operation of the powered system.

In one embodiment, the control system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the control system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of optimized outcomes, which may be weighed relative to each other.

In one embodiment, a method for controlling operation of a powered system is provided. The method may include communicatively coupling processors of a control system with each other by a data plane of a communication network, running software applications in containers using the processors to control operation of the powered system, switching which of the processors are running different ones of the software applications operating in different ones of the containers, and changing a mode of at least one of the containers to a shadow mode that prevents output from at least a first application of the software applications that is running in the at least one of the containers operating in the shadow mode from changing operation of the powered system.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. The scope of the subject matter should, therefore, be determined with reference to the appended claims, along with the full scope of equivalents to which such claims are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The following claims recite inventive features of the subject matter described herein:

1. A powered system comprising:
a control system having processors communicatively coupled with each other by a data plane of a communication network, the processors configured to run software applications in containers to control operation of the powered system, the processors configured to switch which of the processors are running different ones of the software applications operating in different ones of the containers,
the processors configured to change a mode of at least one of the containers to a shadow mode that prevents output from at least a first application of the software applications that is running in the at least one of the containers operating in the shadow mode from changing operation of the powered system.

2. The powered system of claim 1, wherein the control system is configured to provide real time data related to operation of the powered system to the software applications running in the containers in both a non-shadow mode and in the shadow mode along the data plane.

3. The powered system of claim 1, wherein the software applications running in the containers are configured to provide the output based on data received from the data plane, the software applications running in the containers other than the at least one container in the shadow mode configured to provide the output that changes operation of the powered system, the software application or the software applications running in the at least one container in the shadow mode configured to provide the output that does not change the operation of the powered system.

4. The powered system of claim 1, wherein the processors are configured to log or record the output from the software application or the software applications running in the at least one container in the shadow mode.

5. The powered system of claim 1, wherein the processors are configured to change the mode of another container of the containers from a non-shadow mode to the shadow mode.

6. The powered system of claim 1, wherein the processors are configured to change the mode of the at least one of the containers from the shadow mode to a non-shadow mode.

7. The powered system of claim 6, wherein the output from the software application or the software applications running in the at least one of the containers that was switched from the shadow mode to the non-shadow mode changes the operation of the powered system.

8. A method comprising:
communicatively coupling processors of a control system with each other by a data plane of a communication network;
running software applications in containers using the processors to control operation of a powered system;
switching which of the processors are running different ones of the software applications operating in different ones of the containers; and
changing a mode of at least one of the containers to a shadow mode that prevents output from at least a first application of the software applications that is running in the at least one of the containers operating in the shadow mode from changing operation of the powered system.

9. The method of claim 8, further comprising:
providing real time data related to operation of the powered system to the software applications running in the containers in both a non-shadow mode and in the shadow mode along the data plane.

10. The method of claim 8, further comprising:
providing the output from the software applications running in the containers based on data received from the data plane, the software applications running in the containers other than the at least one container in the shadow mode configured to provide the output that changes operation of the powered system, the software application or the software applications running in the at least one container in the shadow mode configured to provide the output that does not change the operation of the powered system.

11. The method of claim 8, further comprising:
logging or recording the output from the software application or the software applications running in the at least one container in the shadow mode.

12. The method of claim 8, further comprising:
changing the mode of another container of the containers from a non-shadow mode to the shadow mode.

13. The method of claim 8, further comprising:
changing the mode of the at least one of the containers from the shadow mode to a non-shadow mode.

14. The method of claim 13, further comprising:
changing the operation of the powered system with the output from the software application or the software applications running in the at least one of the containers that was switched from the shadow mode to the non-shadow mode.

15. A control system comprising:
a control system having processors communicatively coupled with each other by a data plane of a communication network, the processors configured to run software applications in containers to control operation of a powered system, the processors configured to switch the containers between operating in a normal mode and a shadow mode,
the software applications running in the containers in the normal mode generating output that controls operation of the powered system, the software applications running in the containers in the shadow mode generating output that does not control operation of the powered system.

16. The control system of claim 15, wherein the processors are configured to provide real time data related to operation of the powered system to the software applications running in the containers in both the normal mode and in the shadow mode along the data plane.

17. The control system of claim 15, wherein the processors are configured to log or record the output from the software application or the software applications running in the shadow mode.

18. The control system of claim 15, wherein the processors are configured to change at least one of the containers from the normal mode to the shadow mode.

19. The control system of claim 15, wherein the processors are configured to change at least one of the containers from the shadow mode to the normal mode.

20. The control system of claim 19, wherein the output from the software application or the software applications running in the at least one of the containers that was switched from the shadow mode to the normal mode changes the operation of the powered system.
